(19) United States
(12) Patent Application Publication
(10) Pub. No.: US 2025/0308557 A1
(43) Pub. Date: Oct. 2, 2025

(54) TAPE PATH WITH MOVABLE TAPE SUPPORT

(71) Applicant: International Business Machines Corporation, Armonk, NY (US)

(72) Inventors: Mark Alfred Lantz, Adliswil (CH); Hugo E. Rothuizen, Oberrieden (CH); Simeon Furrer, Altdorf (CH); Beat Eugen Weiss, Edlibach (CH); Stella Brach, Oberrieden (CH); Luzius Kronig, Zurich (CH)

(21) Appl. No.: 18/616,936

(22) Filed: Mar. 26, 2024

(51) Int. Cl. G11B 23/04

(52) U.S. Cl. CPC G11B 23/044

(57) ABSTRACT

A moveable tape support assembly. The assembly includes a frame that is moveable, and at least a first roller and a second roller are attached to the frame and are each free to rotate about an axis, and the first roller is in close proximity to the second roller. The frame is moveable in order for the first roller and the second roller to contact a first side of a tape and move the tape in order to have a second side of the tape to contact a head that is adapted for reading data from the tape or writing data to the tape.

### BACKGROUND

The present disclosure generally relates to data storage systems and, more particularly, to tape-based storage systems and components thereof.

In certain computing systems, tape-based storage systems include a tape drive and tape cartridges or cassettes that store tape media (also called tape film or magnetic tape). The tape drive performs writing or reading of data in the cartridges or cassettes.

### SUMMARY

According to some embodiments of the disclosure, there is provided a moveable tape support assembly. The assembly includes a frame that is moveable, and at least a first roller and a second roller are attached to the frame and are each free to rotate about an axis, and the first roller is in close proximity to the second roller. The frame is moveable in order for the first roller and the second roller to contact a first side of a tape and move the tape in order to have a second side of the tape to contact a head that is adapted for reading data from the tape or writing data to the tape.

According to some embodiments of the disclosure, there is provided a moveable tape support assembly. The assembly includes a frame, a head adapted for reading data from a tape or writing data to the tape that is connected to the frame and located on a first side of the tape, and at least a first roller and a second roller located on a second side of the tape, wherein the first roller is in close proximity to the second roller. The frame is moveable in order for the head to contact the first side of the tape.

According to some embodiments of the disclosure, there is provided a tape drive system. The system includes a tape media adapted to store data, at least one reel adapted to unroll the tape media therefrom or roll the tape media thereto, a moveable tape support assembly, and a plurality of rollers rotatable and adapted to move the tape media past the moveable tape support assembly. The assembly includes a frame that is moveable, and at least a first roller and a second roller are attached to the frame and are each free to rotate about an axis, and the first roller is in close proximity to the second roller. The frame is moveable in order for the first roller and the second roller to contact a first side of the tape media and move the tape media in order to have a second side of the tape media to contact a tape head that is adapted for reading data from the tape media or writing data to the tape media.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a top view of a tape drive assembly of a tape-based data storage system, in accordance with an embodiment of the disclosure.

FIG. 2A illustrates a moveable tape support assembly in an unactuated position, in accordance with an embodiment of the disclosure.

FIG. 2B illustrates the moveable tape support assembly of FIG. 2A in an actuated position, in accordance with an embodiment of the disclosure.

FIG. 3A illustrates a moveable tape support assembly in an unactuated position, in accordance with an embodiment of the disclosure.

FIG. 3B illustrates the moveable tape support assembly of FIG. 3A in an actuated position, in accordance with an embodiment of the disclosure.

FIG. 4 is a flow diagram of a method, in accordance with an embodiment of the disclosure.

FIG. 5 is a flow diagram of a method, in accordance with an embodiment of the disclosure.

While the disclosure is amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

It will be readily understood that the components of the present embodiments, as generally described and illustrated in the Figures herein, can be arranged and designed in a wide variety of different configurations. Thus, the following detailed description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification are not necessarily referring to the same embodiment. It should be understood that the various embodiments can be combined with one another, and that any one embodiment can be used to modify another embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

It is to be understood that the present disclosure will be described in terms of a given illustrative architecture; however, other architectures, structures, and process features and steps/blocks can be varied within the scope of the present disclosure. It should be noted that certain features cannot be shown in all figures for the sake of clarity. This is not intended to be interpreted as a limitation of any particular embodiment, or illustration, or scope of the claims.

Computing systems process and record data. Large volumes of data are often stored or transferred to nonvolatile storage media, such as magnetic tape cartridges, for example. Typically, magnetic tape is the most economical, convenient, and secure means of storing or archiving data.

Track density of magnetic tape is the number of data tracks per inch (TPI) in the transverse direction of the tape. Track density is calculated by taking an inverse of track pitch (i.e., the distance between adjacent tracks). Compared to hard disk, the track density of tape is lower by a factor of 12 to 25. This has been necessitated by the challenges associated with track following on a flexible tape substrate and a combination of the dimensional instability of the tape substrate and the multi-track recording, which place additional tolerance requirements on tape. Track density improvement has been identified as an area with potential leverage for advancing tape technology.

Track density scaling can be limited by a track following performance of a magnetic tape head module assembly. It is desirable for magnetic tape to be as light as possible such that a controller can increase its bandwidth and hence follow and correct for high frequency disturbances. Another issue limiting track density scaling can be friction between the magnetic tape head module assembly and tape, which can induce disturbances such as compression waves.

Track density scaling is currently a main driver of tape capacity scaling and is expected to remain so for the foreseeable future. Minimizing tape head module mass and friction becomes increasingly important with each new generation of tape drive that is expected to operate with further reduced track pitch.

Aspects of the present disclosure relate generally to a tape-based storage system. More particularly, the present disclosure provides a moveable tape support assembly. While the present disclosure is not necessarily limited to such applications, various aspects of the disclosure can be appreciated through a discussion of various examples using this context.

Embodiments of the present disclosure include a movable tape support assembly consisting of guide rollers with a short roller-to-roller distance. The guide rollers and a tape head can be together attached on an actuator which can move the assembly into a tape path of a tape media. The guide rollers can be attached on the actuator which can move the guide rollers into the tape path and bring the tape media into contact with the tape head. Alternatively, the tape head can be attached on the actuator, which can move the tape media into contact with the guide rollers.

Embodiments of the present disclosure include an assembly in which guide rollers can guide tape on its backside, and that can be positioned in very close proximity of a writer/reader head in order to ensure good support of tape over the head and reduce the effects of the longitudinal compression waves. In order to allow for threading of the tape, the guide rollers and a head motor assembly (HMA) can be moved apart.

Embodiments of the present disclosure include an assembly in which guide rollers can be attached to an actuator and can be moved into a tape path to wrap tape over a head. An HMA can be fixed. The actuator can push the guide rollers into the tape path which then can push the tape into contact with the head. Retracting the rollers from the head can facilitate threading and unthreading of the tape.

Embodiments of the present disclosure can include an HMA that is attached to an actuator which moves the HMA into a tape path.

Embodiments of the present disclosure can include an assembly that can reduce compression wave disturbance, and also enable a reduction in tape and head wear during seek operations by disengaging the head from the tape.

Embodiments of the present disclosure can provide advantages that can be valuable to the data storage industry. Embodiments of the present disclosure can provide improvements to tape head technology to reduce friction between a tape bearing surface and a magnetic tape medium, for example. In addition, embodiments of the present disclosure can provide low spacing between a tape head and a tape medium in order to improve areal density and cartridge capacity. Furthermore, embodiments of the present disclosure can minimize compression wave effects. Embodiments of the present disclosure can also operate with increased track density. Embodiments of the present disclosure also allow the guide rollers to be retracted from the tape head, which can facilitate threading and unthreading of tape through the assembly.

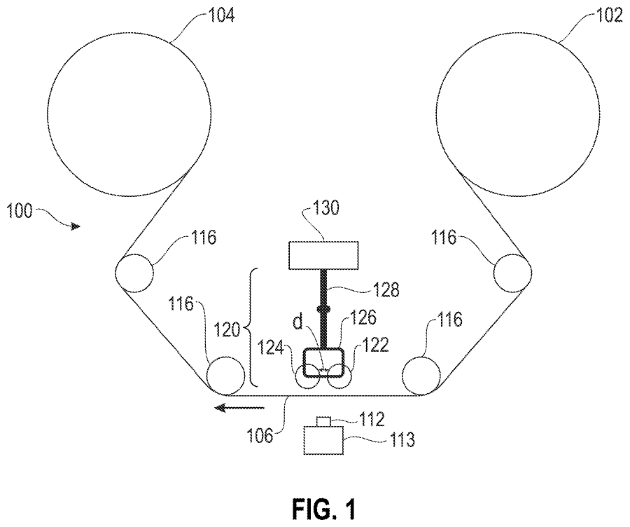

FIG. 1 illustrates a top view of a tape drive assembly 100 of a tape-based data storage system, in accordance with an embodiment of the disclosure. While one specific implementation of a tape drive is shown in FIG. 1, it should be noted that the embodiments described herein can be implemented in the context of any type of a tape drive assembly/system. As shown, a tape supply cartridge 102 (or reel) and a take-up reel 104 are provided to support a tape 106 and provide or take up the tape 106 in the tape drive assembly 100. At least one reel tape (i.e., the supply cartridge 102) can be adapted to unroll the tape 106 therefrom or roll the tape 106 thereto (i.e., the take-up reel 104). One or more of the reels can form part of a removable cassette and are not necessarily part of the tape drive assembly 100. The tape drive assembly 100, such as that illustrated in FIG. 1, can further include drive motor(s) to drive the tape supply cartridge 102 and the take-up reel 104 to move the tape 106 through the tape drive assembly 100.

The tape drive assembly 100 shown includes an HMA 113 that includes a tape head 112. The tape head 112 can be, for example, a magnetic tape head module that can include a plurality of arrays of data transducers. The tape head 112 can be any suitable device that can read and/or write on tape media. The tape head 112 (or “head” or “mini tape head” or “mini head”) can contain one or more head modules that contain one or more write transducers used in tape recorders that can convert electrical signals to magnetic ones and/or one or more read transducers that can convert magnetic signals to electrical signals. The tape head 112 can include, for example, three tape head modules, including two write transducer modules and one read transducer module.

In the tape drive assembly 100, the tape 106 can be magnetic and can be moved over a surface of the tape head 112 at a high speed. The tape 106 can move in a direction of travel as indicated by the arrow in FIG. 1 as it moves over the tape head 112, for example.

A number of rollers 116 can be included in the tape drive assembly 100 in order to move the tape 106. The four (4) additional rollers 116 shown are an example, and other numbers and configurations of the additional rollers 116 are also contemplated.

FIG. 1 includes an embodiment of a moveable tape support assembly 120. The moveable tape support assembly 120 can include two or more guide rollers, such as a first guide roller 122 and a second guide roller 124, both connected to an actuatable frame 126. The first and second guide rollers 122, 124 can be attached to the actuatable frame 126 such that the first and second guide rollers 122, 124 can be rotatable about an axis. The actuatable frame 126 can be attached to an actuator 128 that can be connected to an actuator controller 130 that can control movement of the moveable tape support assembly 120 either towards or away from the tape 106 and the tape head 112 and HMA 113 in order to contact the tape 106 with the tape head 112. The actuator 128 and the actuatable frame 126 shown are examples any other suitable actuators and actuatable frames are also contemplated by the present disclosure.

As shown, dis the distance between the first guide roller 122 and the second guide roller 124. In one embodiment, d can be in a range of 0.1 mm to 2.0 mm. In another embodiment, d can be in a range of 0.1 mm to 1.0 mm.

The tape head 112 is narrower than a full width of the tape 106. In one embodiment, the ratio of the width of the tape head 112 to the width of the tape 106 can be less than 1, or in a range from about 0.14 to about 0.55. The widths of the tape 106 and the tape head 112 are into the page in FIG. 1.

The guide rollers 122, 124 can include a cylinder body that is mounted on ball bearings such that it can rotate. The guide rollers 122, 124 can have a smooth surface and an air bearing can result when using the guide rollers 122, 124 in the tape drive assembly 100 of FIG. 1, for example. Alternatively, the guide rollers 122, 124 can include a cylindrical-shaped body that include a plurality of grooves that can suppress production of an air bearing. The tape 106 can continuously be in contact with the guide rollers 122, 124 and no air bearing may form if used in the tape drive assembly 100, for example. The guide rollers 122, 124 with the grooves can advantageously reduce or eliminate compression wave disturbance. Due to the grooves, there may be negligible or no friction as long as the tape 106 does not slip on the guide rollers 122, 124. There may be some friction in the bearings of the guide rollers 122, 124.

The tape drive assembly 100 as shown can include a single reel cartridge, such as the tape supply cartridge 102, and a take-up reel 104 in the tape drive assembly 100. The tape drive assembly 100 can use precisely controlled motors to wind the tape 106 from one reel to the other, passing the read/write tape head 112 as it does.

The tape drive assembly 100 can include other components that are not shown. For example, the tape head 112 can be coupled to a controller. The controller can be or include a processor and/or any logic for controlling any subsystem of the tape drive assembly 100. For example, the controller can control functions of the tape head 112 such as data writing, data reading, etc. The controller can operate under logic known in the art. The controller can be coupled to a memory of any known type, which can store instructions executable by the controller. Moreover, the controller can be configured and/or programmable to perform or control any desired methodology.

A tape-based data storage system that includes the tape drive assembly 100 can include other components as well. For example, the tape-based data storage system can include an interface (not shown). The interface can be provided for communication between the tape drive assembly 100 and a host (integral or external) to send and receive data and for controlling the operation of the tape drive assembly 100 and communicating the status of the tape drive assembly 100 to the host.

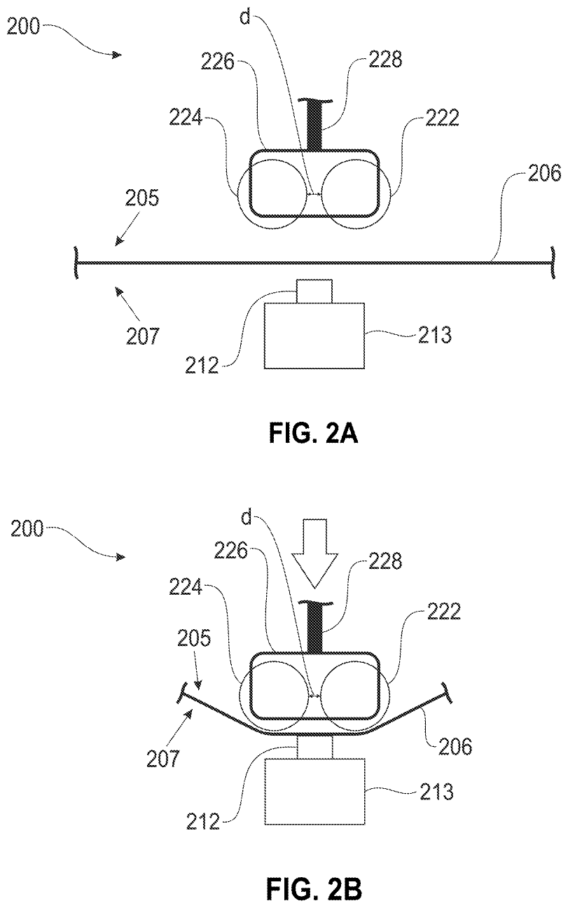

FIGS. 2A and 2B illustrate a moveable tape support assembly 200 in an unactuated position (FIG. 2A) and an actuated position (FIG. 2B), in accordance with an embodiment of the disclosure. The moveable tape support assembly 200 can be included in a tape drive, such as the tape drive assembly 100 in FIG. 1. As shown, the moveable tape support assembly 200 can include two or more guide rollers, such as a first guide roller 222 and a second guide roller 224, both connected to an actuatable frame 226.

As shown, dis the distance between the first guide roller 222 and the second guide roller 224. In one embodiment, d can be in a range of 0.1 mm to 2.0 mm. In another embodiment, d can be in a range of 0.1 mm to 1.0 mm.

The first and second guide rollers 222, 224 can be attached to the actuatable frame 226 such that the first and second guide rollers 222, 224 can each be rotatable about an axis. The actuatable frame 226 can maintain the roller-to-roller distance 223 between the first guide roller 224 and the second guide roller 224. The actuatable frame 226 can be attached to an actuator 228 that can provide movement of the actuatable frame 226 in order to move the actuatable frame 226 (being in the actuated position, as in FIG. 2B) towards a first side 205 of the tape 206 in order to contact the tape 206 with a tape head 212 located on an HMA 213. The actuator 228 can move the moveable tape support assembly 200 into a path of the tape 206. While in the actuated position, as in FIG. 2B, the first guide roller 222 and the second guide roller 224 can rotate in order to allow the tape 206 to move by the tape head 212, while a second side 207 of the tape 206 contacts the tape head 212, as the tape 206 is being read from or written onto, for example. The first guide roller 222 and the second guide roller 224 and the tape head 212 can be on opposite sides (i.e., the first side 205 and the second side 207) of the tape 206. The actuated position of the moveable tape support assembly 200 also can ensure a short or stiff span of the tape 206 that can achieve a stable interface between the tape head 212 and the tape 206.

The tape head 212 is narrower than the width of the tape 206. In one embodiment, the ratio of the width of the tape head 212 to the width of the tape 206 can be less than 1, or in a range from about 0.14 to about 0.55. The widths of the tape 206 and the tape head 212 are into the page in FIGS. 2A-2B.

The guide rollers 222, 224 can include a cylinder body that is mounted on ball bearings such that it can rotate. The guide rollers 222, 224 can have a smooth surface and an air bearing can result when used in a tape drive. Alternatively, the guide rollers 222, 224 can include a cylindrical-shaped body that include a plurality of grooves that can suppress production of an air bearing. The tape 206 can continuously be in contact with the guide rollers 222, 224 and no air bearing may form. The guide rollers 222, 224 with the grooves can advantageously reduce or eliminate compression wave disturbance. Due to the grooves, there may be negligible or no friction as long as the tape 206 does not slip on the guide rollers 222, 224. There may be some friction in the bearings of the guide rollers 222, 224.

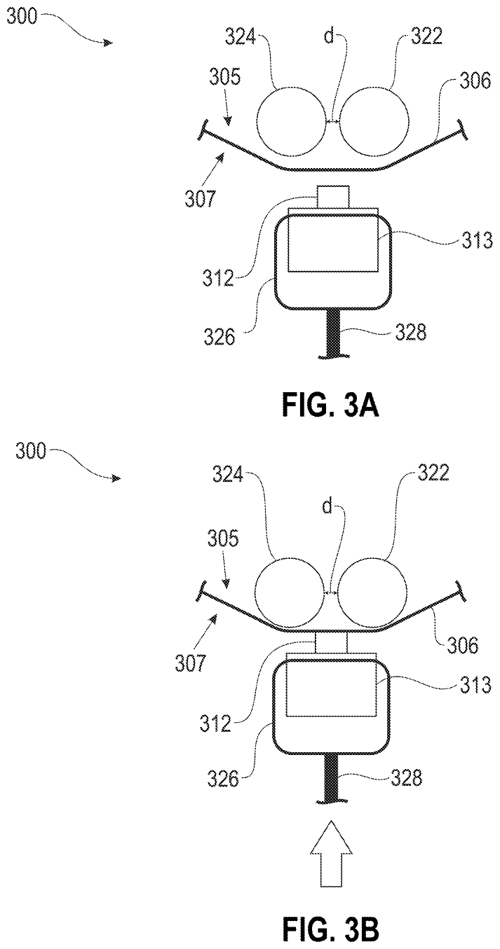

FIGS. 3A and 3B illustrate a moveable tape support assembly 300 in an unactuated position (FIG. 3A) and an actuated position (FIG. 3B), in accordance with an embodiment of the disclosure. The moveable tape support assembly 300 can be included in a tape drive, such as the tape drive assembly 100 in FIG. 1. As shown, the moveable tape support assembly 300 can include two or more guide rollers, such as a first guide roller 322 and a second guide roller 324 on a first side 305 of a tape 306. The first and second guide rollers 322, 324 can be attached to another component, that is not shown in the figure, which can maintain the roller-to-roller distance. The first and second guide rollers 322, 324 can each be rotatable about an axis. The moveable tape support assembly 300 can include to an actuatable frame 326 connected to a tape head 312 and an HMA 313 combination. The actuatable frame 326 can also be attached to an actuator 328 that can provide movement of the actuatable frame 326 in order to move the actuatable frame 326 (being in the actuated position, as in FIG. 3B) towards a second side 307 of the tape 306, with the tape head 312 attached, in order to contact the tape 306 with the tape head 312. The actuator 328 can move the moveable tape support assembly 300 into a path of the tape 306. While in the actuated position, as in FIG. 3B, the first guide roller 322 and the second guide roller 324 can rotate in order to allow the tape 306 to move by the tape head 312 and contact the tape head 312, as the tape 306 is being read from or written onto, for example. The actuated position of the moveable tape support assembly 300 also can ensure a short or stiff span of the tape 306 that can achieve a stable interface between the tape head 312 and the tape 306.

As shown, dis the distance between the first guide roller 322 and the second guide roller 324. In one embodiment, d can be in a range of 0.1 mm to 2.0 mm. In another embodiment, d can be in a range of 0.1 mm to 1.0 mm.

The tape head 312 is narrower than the width of the tape 306. In one embodiment, the ratio of the width of the tape head 312 to the width of the tape 306 can be less than 1, or in a range from about 0.14 to about 0.55. The widths of the tape 306 and the tape head 312 are into the page in FIGS. 3A-3B.

The guide rollers 322, 324 can include a cylinder body that is mounted on ball bearings such that it can rotate. The guide rollers 322, 324 can have a smooth surface and an air bearing can result when used in a tape drive. Alternatively, the guide rollers 322, 324 can include a cylindrical-shaped body that include a plurality of grooves that can suppress production of an air bearing. The tape 306 can continuously be in contact with the guide rollers 322, 324 and no air bearing may form. The guide rollers 322, 324 with the grooves can advantageously reduce or eliminate compression wave disturbance. Due to the grooves, there may be negligible or no friction as long as the tape 306 does not slip on the guide rollers 322, 324. There may be some friction in the bearings of the guide rollers 322, 324.

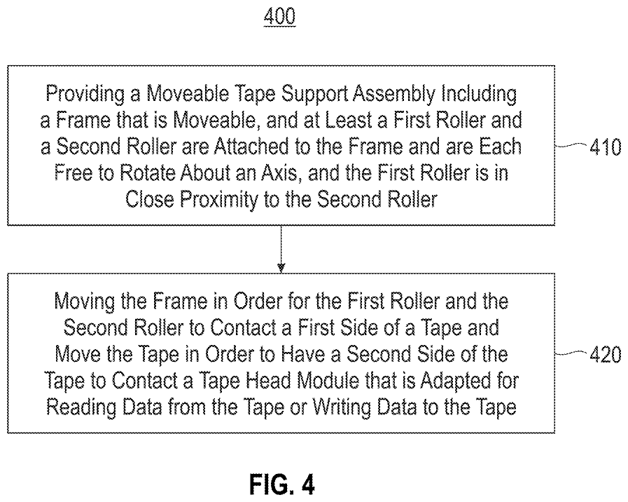

FIG. 4 is a flow diagram of a method 400, in accordance with an embodiment of the disclosure. The method 400 is one example of a method of the present disclosure, and others are contemplated. One operation 410 is providing a moveable tape support assembly including a frame that is moveable, and at least a first roller and a second roller are attached to the frame and are each free to rotate about an axis, and the first roller is in close proximity to the second roller. Another operation 420 is moving the frame in order for the first roller and the second roller to contact a first side of a tape and move the tape in order to have a second side of the tape contact a tape head that is adapted for reading data from the tape or writing data to the tape.

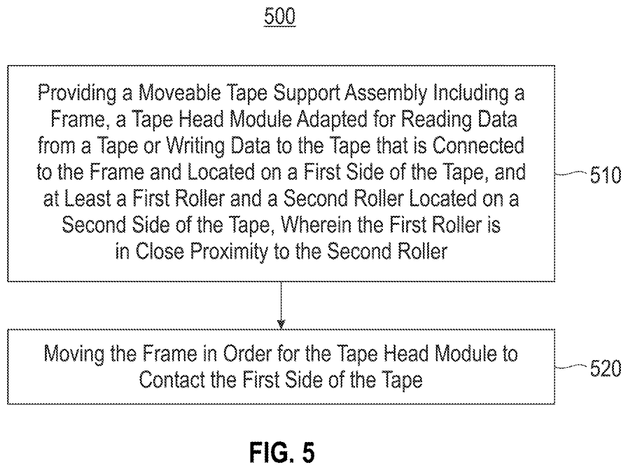

FIG. 5 is a flow diagram of a method 500, in accordance with an embodiment of the disclosure. The method 500 is one example of a method of the present disclosure, and others are contemplated. One operation 510 is providing a moveable tape support assembly including a frame, a head adapted for reading data from a tape or writing data to the tape that is connected to the frame and located on a first side of the tape, and at least a first roller and a second roller located on a second side of the tape, wherein the first roller is in close proximity to the second roller. Another operation 520 is moving the frame in order for the head to contact the first side of the tape and move the tape in order to have the second side of the tape contact the first roller and the second roller.

For purposes of this description, certain aspects, advantages, and novel features of the embodiments of this disclosure are described herein. The disclosed processes, and systems should not be construed as being limiting in any way. Instead, the present disclosure is directed toward all novel and nonobvious features and aspects of the various disclosed embodiments, alone and in various combinations and sub-combinations with one another. The processes, and systems are not limited to any specific aspect or feature or combination thereof, nor do the disclosed embodiments require that any one or more specific advantages be present, or problems be solved.

Although the operations of some of the disclosed embodiments are described in a particular, sequential order for convenient presentation, it should be understood that this manner of description encompasses rearrangement, unless a particular ordering is required by specific language set forth below. For example, operations described sequentially can in some cases be rearranged or performed concurrently. Moreover, for the sake of simplicity, the attached figures may not show the various ways in which the disclosed processes can be used in conjunction with other processes. Additionally, the description sometimes uses terms like “provide” or “achieve” to describe the disclosed processes. These terms are high-level abstractions of the actual operations that are performed. The actual operations that correspond to these terms can vary depending on the particular implementation and are readily discernible by one of ordinary skill in the art.

As used in this application and in the claims, the singular forms “a,” “an,” and “the” include the plural forms unless the context clearly dictates otherwise. Additionally, the term “includes” means “comprises.”

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A moveable tape support assembly, the assembly comprising:
a frame that is moveable; and
at least a first roller and a second roller are attached to the frame and are each free to rotate about an axis, and the first roller is in close proximity to the second roller,
wherein the frame is moveable in order for the first roller and the second roller to contact a first side of a tape and move the tape in order to have a second side of the tape to contact a head that is adapted for reading data from the tape or writing data to the tape.

2. The moveable tape support assembly of claim 1, wherein the head is a mini head that does not span a full width of the tape.

3. The moveable tape support assembly of claim 1, wherein a distance between the first roller and the second roller is in a range of 0.1 mm to 2.0 mm.

4. The moveable tape support assembly of claim 1, wherein the frame and the head are located on opposite sides of the tape.

5. The moveable tape support assembly of claim 1, wherein the frame is moveable in order to move the first roller and the second roller into a path of the tape.

6. The moveable tape support assembly of claim 1, wherein the first roller and the second roller are arranged to ensure that when the first roller and the second roller contact the first side of the tape, the tape includes a short and stiff span near the head in order to achieve a stable head/tape interface.

7. The moveable tape support assembly of claim 1, wherein the frame is attached to an actuator and the actuator is controlled in order to move the frame.

8. A moveable tape support assembly, the assembly comprising:
a frame;
a head adapted for reading data from a tape or writing data to the tape that is connected to the frame and located on a first side of the tape; and
at least a first roller and a second roller located on a second side of the tape, wherein the first roller is in close proximity to the second roller,
wherein the frame is moveable in order for the head to contact the first side of the tape.

9. The moveable tape support assembly of claim 8, wherein the head is a mini head that does not span a full width of the tape.

10. The moveable tape support assembly of claim 8, wherein a distance between the first roller and the second roller is in a range of 0.1 mm to 2.0 mm.

11. The moveable tape support assembly of claim 8, wherein the frame and the head are on opposite sides of the tape.

12. The moveable tape support assembly of claim 8, wherein the frame is moveable in order to move the first roller and the second roller into a path of the tape.

13. The moveable tape support assembly of claim 8, wherein the first roller and the second roller are arranged to ensure that when the first roller and the second roller contact the first side of the tape, the tape includes a short and stiff span near the head in order to achieve a stable head/tape interface.

14. The moveable tape support assembly of claim 8, wherein the frame is attached to an actuator and the actuator is controlled in order to move the frame.

15. A tape drive system comprising:
a tape media adapted to store data;
at least one reel adapted to unroll the tape media therefrom or roll the tape media thereto;
a moveable tape support assembly including:
a frame that is moveable, and
at least a first roller and a second roller are attached to the frame and are each free to rotate about an axis, and the first roller is in close proximity to the second roller,
wherein the frame is moveable in order for the first roller and the second roller to contact a first side of the tape media and move the tape media in order to have a second side of the tape media to contact a tape head that is adapted for reading data from the tape media or writing data to the tape media; and
a plurality of rollers rotatable and adapted to move the tape media past the moveable tape support assembly.

16. The tape drive system of claim 15, wherein the tape head is a mini head.

17. The tape drive system of claim 15, wherein a distance between the first roller and the second roller is in a range of 0.1 mm to 2.0 mm.

18. The tape drive system of claim 15, wherein the frame and the tape head are on opposite sides of the tape media.

19. The tape drive system of claim 15, wherein the frame is moveable in order to move the first roller and the second roller into a path of the tape media.

20. The tape drive system of claim 15, wherein the first roller and the second roller are arranged to ensure that when the first roller and the second roller contact the first side of the tape media, the tape media includes a short and stiff span near the tape head in order to achieve an interface between the tape head and the tape media.
